(19) United States
(12) Patent Application Publication
(10) Pub. No.: US 2013/0326253 A1
(43) Pub. Date: Dec. 5, 2013

(54) TOGGLING SLEEP-MODE OF A MOBILE DEVICE WITHOUT MECHANICAL OR ELECTROMAGNETIC TOGGLING BUTTONS

(71) Applicants: Wilfred LAM, Los Altos, CA (US); Rakesh RAMDE, Los Altos, CA (US); Amanjyot Singh JOHAR, Fremont, CA (US)

(72) Inventors: Wilfred LAM, Los Altos, CA (US); Rakesh RAMDE, Los Altos, CA (US); Amanjyot Singh JOHAR, Fremont, CA (US)

(21) Appl. No.: 13/843,349

(22) Filed: Mar. 15, 2013

Related U.S. Application Data
(60) Provisional application No. 61/689,274, filed on Jun. 1, 2012.
(60) Provisional application No. 61/689,632, filed on Jun. 8, 2012.

(51) Int. Cl. G06F 1/32

(52) U.S. Cl. CPC G06F 1/3206
USPC 713/323

(57) ABSTRACT

Techniques for toggling sleep modes. A gesture associated with the mobile device that is in a first mode is detected. The can be gesture indicative of a user toggling the sleep mode of the mobile device from a first mode. Responsive to the gesture, the first mode can be switched to a second mode. In the second mode at least one component of the mobile device is either powered-up or powered-down.

### CROSS-REFERENCES TO RELATED APPLICATIONS

This application claims priority under 35 USC 119(e) to U.S. Pat. App. No. 61/689,274, entitled NON-ELECTROMAGNETIC METHOD AND APPARATUS FOR TOGGLING SLEEP MODE OF A MOBILE DEVICE WITHOUT MECHANICAL SLEEP-MODE TOGGLING BUTTONS, by Wilfred LAM et al., and to U.S. Pat. App. No. 61/689,632, entitled NON-ELECTROMAGNETIC METHOD AND APPARATUS FOR TOGGLING SLEEP MODE OF A MOBILE DEVICE WITHOUT MECHANICAL SLEEP-MODE TOGGLING BUTTONS, by Wilfred LAM et al., the contents of each of which are being hereby incorporated by reference in their entirety.

### FIELD OF THE INVENTION

The invention relates generally to power control and more specifically, toggling sleep modes of a mobile device.

### BACKGROUND OF THE INVENTION

Recent mobile devices have become the main form of computer interaction for many users. Further, social networks, e-mail, blogs, and other applications accessed on these mobile devices are constantly updated as users have more intermittent interactions. As such, users are constantly checking smart phones, tablets, and other emerging classes of mobile devices numerous times per day. Each time, a mobile device is woken up from a sleep mode for an interaction and then put to sleep afterwards.

Sleep modes are conventionally referred to a state of mobile devices that is between powered up and powered down. In one example, non-essential, power-consuming functions such as screen display and updating are halted during sleep mode, while essential functions such as notification of an incoming telephone call or SMS text messages are continued. The resulting power savings can extend the battery life of mobile devices.

Unfortunately, mobile devices typically rely upon mechanical toggling buttons for waking up and putting mobile devices to sleep. Users depress buttons on the bottom of the device or on the side for actuation. As display areas for mobile devices continue to increase, the real estate consumed by mechanical toggling buttons limit the potential display area for a particular form factor. Additionally, mechanical toggling buttons located on the side can limit the thinness of mobile devices, affecting the form factor itself.

Moreover, while electromagnetic toggling buttons for waking up and putting mobile devices to sleep also consume real estate and can be expensive. In particular, a case around mobile devices with a magnet implanted generates a magnetic field which, in turn, generates a current as an electrical signal for putting mobile devices to sleep when closed (i.e., when in contact with the electromagnetic toggling buttons. When the case is opened, the magnetic field is broken, thereby ceasing the electrical current, signifying a wake up. However, these electromagnetic toggling buttons still consume real estate. Other additional parts for electromagnetic shielding may also be necessary

What is needed is a robust technique for toggling sleep mode of a mobile device without mechanical toggling buttons, while overcoming the deficiencies of the prior art.

### SUMMARY

To meet the above-described needs, methods, computer program products, and systems for toggling sleep mode of a mobile device without mechanical or electromagnetic toggling buttons.

In one embodiment, a gesture associated with the mobile device that is in a first mode is detected. The can be gesture indicative of a user toggling the sleep mode of the mobile device from a first mode. The gesture can be a physical or non-physical interaction with the mobile device 110 relative to an X, Y and/or Z axes. Exemplary gestures include a 1-dimensional hand motion, a 2-dimensional hand motion, a 3-dimensional hand motion, a tap, a bump, a shake, a sequence of taps, and the like.

Responsive to the gesture, the first mode can be switched to a second mode. In the second mode at least one component of the mobile device is either powered-up or powered-down.

Advantageously, users can toggle sleep modes of a mobile device without wasting the space of mechanical buttons or dealing with the complexity of electromagnetic buttons.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level schematic diagram illustrating a mobile device to toggle sleep modes without mechanical or electromagnetic toggling buttons, according to one embodiment.

FIG. 2 is a high-level block diagram illustrating a mobile device to toggle sleep modes without mechanical or electromagnetic toggling buttons, according to one embodiment, according to one embodiment.

FIG. 3 is a block diagram illustrating an exemplary computing device, according to one embodiment.

FIG. 4 is a high-level flow diagram illustrating a method for toggling sleep modes of a mobile device without mechanical or electromagnetic toggling buttons, according to one embodiment.

### DETAILED DESCRIPTION

The present invention provides methods, computer program products, and systems for toggling sleep mode of a mobile device without electromagnetic toggling buttons.

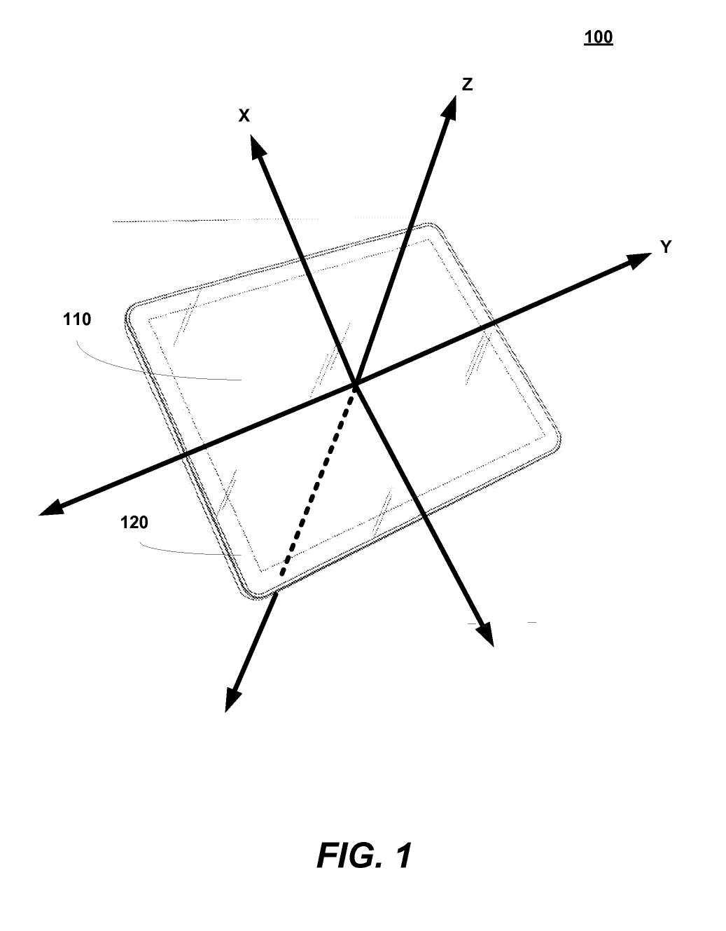

Sleep Mode Toggling Systems (FIGS. 1-3)

FIG. 1 is a high-level schematic diagram illustrating a mobile device 100 to toggle sleep modes without mechanical or electromagnetic toggling buttons, according to one embodiment. The mobile device 100 includes a display screen 110 and a frame 120.

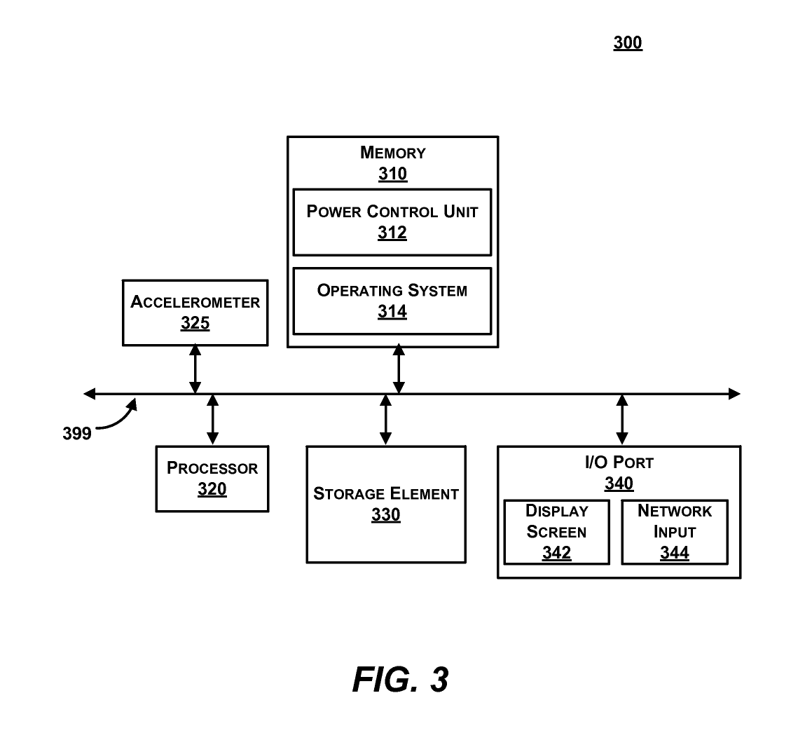

The mobile device 100 can be a smart phone, a tablet device (e.g., an iPad), a gaming device, a wearable device (e.g., virtual reality glasses), a laptop, a mobile computer, an Internet appliance, or any computing device as described generically in FIG. 3. In one embodiment, a gesture from a user toggles the mobile device 100 between sleep modes (or states). The gesture can be a physical or non-physical interaction with the mobile device 110 relative to an X, Y and/or Z axes. Exemplary gestures include a 1-dimensional hand motion, a 2-dimensional hand motion, a 3-dimensional hand motion, a tap, a bump, a shake, a sequence of taps, and the like. One or more different gestures may be acceptable. Different gestures can signify different levels of sleep mode. In additional embodiments, gestures can be hard-coded or configurable.

There can be a first mode and a second mode, or any number of intermediate modes (e.g., three or more modes) spanning from completely powered-down (i.e., all components unpowered), to sleep (i.e., some components or parts of components powered-down and some components powered-up), to completely powered-up (i.e., all components powered-up). Some implementations of the mobile device 100 can also include the traditional mechanical or electromagnetic toggle buttons, but they are not required for controlling sleep modes.

In some embodiments, a user periodically interacts with the mobile device 100 at various intervals. For example, a smart phone user can switch modes to perform an Internet search, switch modes to check e-mail two minutes later, switch modes to send a text message five minutes later, and then switch modes to view photographs an hour later. The periods of downtime can vary in length, or be predetermined, over any suitable range.

The display screen 110 can be a touch screen, a non-touch screen, a virtual reality display, a TFT (thin film transistor) type of LCD (liquid crystal display), or any suitable type of display technology. In some embodiments, the display screen 110 can receive the gesture, either passively or actively. In the passive case, a certain bump to the display screen 110 passes through to a sensor. In the active case, a low-power sensor can detect a possible gesture, and the screen can be activated in a low-power mode to receive and validate the gesture before fully powering up.

The frame 120 can be composed of metal, plastic, rubber, or any combination of appropriate materials. The display screen 110 can support and protect the display screen 110. Because toggling buttons can be eliminated, the display screen 110 can be substantially the same length and width dimensions as the frame 120 allowing for a larger display area. In one embodiment, a physical gesture can be received by the frame.

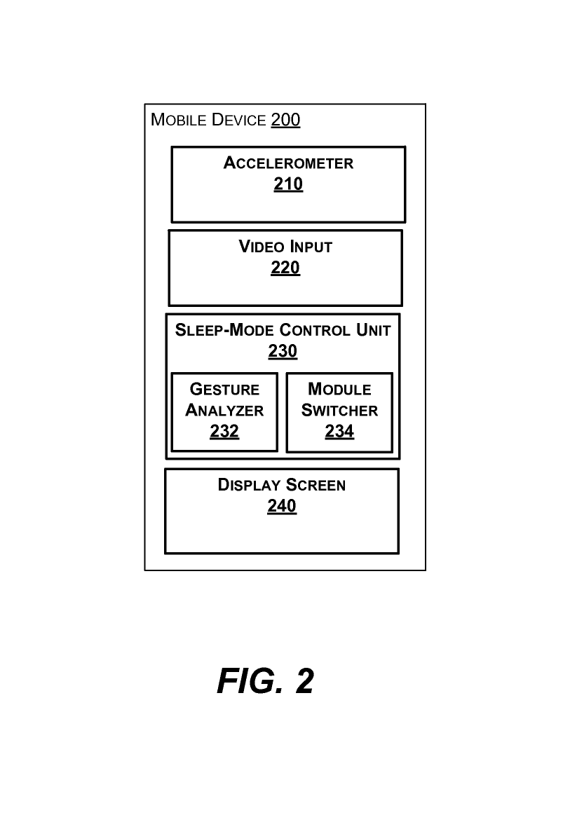

FIG. 2 is a high-level block diagram illustrating a system to toggle sleep modes of a mobile device 200 without mechanical or electromagnetic toggling buttons, according to one embodiment, according to one embodiment. The mobile device 200 includes an accelerometer 210, a video input 220, a sleep mode control unit 230 and a display screen 240.

The accelerometer 210 detects and measures movement in the mobile device 200. The movement can be relative to X, Y and/or Z axes. The accelerometer 210 can be a low-power device that stays on from long periods of time without a significant consumption of battery life or power. In some implementations, the accelerometer 210 itself is activated by a sensor. Outputs of the accelerometer 210 can be a current or voltage varies with intensity. For example, 2-dimensional shaking strictly along the X and Y axes would result in current or voltage from an X output and a Y output and no current or voltage from a Z output. A digital output can send measurement data as bits.

The optional video input 220 can receive video data from a camera associated or integrated with the mobile device 200. In this option, non-physical gestures can be detected from video content. Alternative types of inputs can connect to motion sensors or audio feeds.

The sleep mode control unit 230 determines the validity of a gesture and powers down one more components. The sleep mode control unit 230 further comprises a gesture analyzer 232 and a module switcher 234. The gesture analyzer receives raw output from a sensor such as the accelerometer 210, the video input 220, or any other module capable of receiving gesture input. The data is compared against predetermined thresholds that can be hard coded or dynamically set by a user. For example, the user may customize gestures by inputting a training gesture.

Once the threshold is surpassed, the module switcher 234 implements a desired mode. When transitioning from sleep mode to a powered-up mode, the module switcher 234 can send a single signal to turn on all components, or can individually signal components. Likewise, when transitioning from a powered-up mode to a sleep mode, signals are sent to components. In one embodiment, the module switcher 234 cuts power to a component using switch.

The display screen 240 can be an input to the sleep mode control unit 130 to send gesture data, and/or an output as a component that is toggled.

FIG. 3 is a block diagram illustrating an exemplary computing device 300 of FIG. 2, according to one embodiment.

The computing device 300, of the present embodiment, includes a memory 310, a processor 320, a storage drive 330, and an I/O port 340. Each of the components is coupled for electronic communication via a bus 399. Communication can be digital and/or analog, and use any suitable protocol.

The memory 310 further comprises a power control unit 312 and an operating system 314. Other modules stored in memory can include a web browser application, a web-browser-based application, a mobile application, a streamed application, a locally-installed application, and the like.

The power control unit 312 can be the modules described in FIG. 2. The operating system 314 can be one of the Microsoft Windows® family of operating systems (e.g., Windows 2000, Windows XP, Windows XP x34 Edition, Windows Vista, Widows 7, Windows 8, Windows CE, Windows Mobile), Linux, HP-UX, UNIX, Sun OS, Solaris, Mac OS X, Alpha OS, AIX, IRIX32, or IRIX34. Other operating systems may be used. Microsoft Windows is a trademark of Microsoft Corporation.

The processor 320 can be a general purpose processor, an application-specific integrated circuit (ASIC), a field programmable gate array (FPGA), a reduced instruction set controller (RISC) processor, an integrated circuit, or the like. A video processor can be optimized for repeated operations. The processor 320 can be single core, multiple core, or include more than one processing elements. The processor 320 can be disposed on silicon or any other suitable material. The processor 320 can receive and execute instructions and data stored in the memory 310 or the storage drive 330

The storage drive 330 can be any non-volatile type of storage such as a magnetic disc, EEPROM, Flash, or the like. The storage drive 330 stores code and data for applications.

The I/O port 340 further comprises a display screen (as described above) 342 and a network input 344. The network input 344 can interface with networks such as the Internet or a 3G network.

Many of the functionalities described herein can be implemented with computer software, computer hardware, computer firmware, or a combination.

Computer software products (e.g., non-transitory computer products storing source code) may be written in any of various suitable programming languages, such as C, C++, C#, Java, JavaScript, PHP, Python, Perl, Ruby, and AJAX. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Bluetooth, LTE, Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

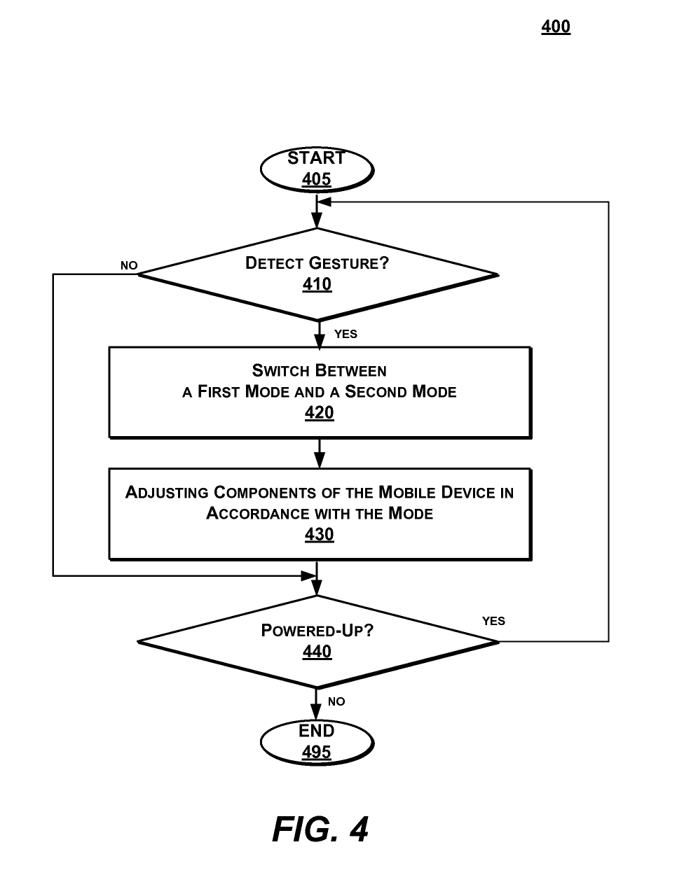

Sleep Mode Toggling Methods (FIG. 4)

FIG. 4 is a high-level flow diagram illustrating a method for toggling sleep modes of a mobile device without mechanical or electromagnetic toggling buttons, according to one embodiment. The method 400 can be implemented, in one embodiment, using the mobile device of FIGS. 1 and 2. Moreover, the method 400 can be implemented in software, hardware, or a combination of both. The method 400 can be automatically performed (once initialized) without human intervention.

At step 410, if a gesture is detected, a mobile device is switched between a first and a second mode (i.e., first to second mode, or second to first mode). The gesture can be detected by the above-descried accelerometer, video input, or the like. If no gesture is detected, the process continues unless the mobile device is powered down. The switch can be between more than two modes.

At step 430, components of the mobile device are adjusted in accordance with the second mode. When entering a sleep mode, one or more components are powered-down. When exiting the sleep mode, one or more components are powered-up.

At step 440, the process awaits gesture detection to change modes again, unless the mobile device is powered-down.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A computer-implemented method for toggling sleep modes of a mobile device, the method comprising:
detecting a gesture associated with the mobile device that is in a first mode, the gesture being indicative of a user toggling the sleep mode of the mobile device from a first mode;
responsive to the gesture, switching to a second mode from a the first mode; and
adjusting at least one component of the mobile device in accordance with the second mode.

2. The method of claim 1, wherein the gesture comprises a physical interaction with the mobile device.

3. The method of claim 2, wherein the physical interaction involves at least a portion of the display screen of the mobile device.

4. The method of claim 3, wherein the physical interaction the physical interaction involves a portion of the display screen according to a predetermined pattern.

5. The method of claim 2, wherein the physical gesture involves at least a portion of the frame of the mobile device.

6. The method of claim 1, wherein the gesture comprises a non-physical interaction with the mobile device.

7. The method of claim 1, wherein the gesture comprises at least one of: a 1-dimensional hand motion, a 2-dimensional hand motion, a 3-dimensional hand motion, a tap, a bump, a shake, and a sequence of taps.

8. The method of claim 1, wherein a display screen on a front side of the mobile device consumes substantially all of the front side.

9. The method of claim 1, wherein the mobile device is button-less.

10. The method of claim 1, further comprising:
detecting a second gesture associated mobile device, the second gesture being indicative of the user toggling the sleep mode of the mobile device from the second mode;
responsive to the second gesture, switching from the second mode back to the first mode; and
adjusting components of the mobile device in accordance with the first mode.

11. The method of claim 1, wherein the first mode comprises a sleep mode and the second mode comprises a powered-up mode.

12. A non-transitory computer-readable medium storing source code that, when executed by a processor, performs a method for toggling sleep modes of a mobile device, the method comprising:
detecting a gesture associated with the mobile device that is in first mode, the gesture being indicative of a user toggling the sleep mode of the mobile device from a first mode;
responsive to the gesture, switching to a second mode from a the first mode; and
adjusting at least one component of the mobile device in accordance with the second mode.

13. A mobile device to toggle sleep modes, the mobile device comprising:
an accelerometer to detect a gesture associated with the mobile device that is in a first mode, the gesture being indicative of a user toggling the sleep mode of the mobile device from a first mode;
a power control unit to, responsive to the gesture, switch to a second mode from a the first mode; and
at least one component to adjust in accordance with the second mode.
